(19) United States
(12) Patent Application Publication
(10) Pub. No.: US 2006/0267764 A1
(43) Pub. Date: Nov. 30, 2006

(54) Object detection sensor

(75) Inventors: Mitsutoshi Morinaga, Kokubunji (JP); Toshiyuki Nagasaku, Sagamihara (JP)

Correspondence Address: MILES & STOCKBRIDGE PC, 1751 PINNACLE DRIVE, SUITE 500, MCLEAN, VA, 22102-3833, US

(73) Assignee: Hitachi, Ltd.

(21) Appl. No.: 11/441,172

(22) Filed: May 26, 2006

(30) Foreign Application Priority Data
May 30, 2005 (JP) 2005-156719

(51) Int. Cl. G01S 13/00; G08B 13/08

(52) U.S. Cl. 340/545.3; 342/28

(57) ABSTRACT

An object detection sensor, which can accurately measure the position of an object within a predetermined monitoring area including the vicinity of a position directly under a sensor, is provided. A monitoring area is divided into a plurality of sections and the distances to the section from the sensor are different from one another. A plurality of antennas designed to monitor the each sections respectively are switched therebetween in use. A signal processing circuit performs a calculation for determining a position and a height of an object within a monitoring surface in the area including the position directly under the sensor set, making use of output information of a radar and taking a radiation path into consideration.

### CLAIM OF PRIORITY

The present patent application claims priority from Japanese application JP No. 2005-156719 filed on May 30, 2005, the content of which is hereby incorporated by reference into this application.

### FIELD OF THE INVENTION

The present invention relates to an object detection sensor for detecting an object indoors and outdoors, and more particularly, to an object detection sensor for detecting an object having a height, such as a person, from above.

### BACKGROUND OF THE INVENTION

As for object detection sensors which are not affected easily by a change in surrounding environment, such as weather, or day or night, for example, Japanese Patent Laid-open No. 2000-338231 (patent document 1) discloses an intrusion detection sensor which employs a radar to detect an intruder. As another example, Japanese Patent Laid-open No. 2003-187342 (patent document 2) discloses an intruder detection system which employs a radar which radiates millimeter wave from a building to a predetermined area outside the building. As a further example, Japanese Patent Laid-open No. 2004-199122 (patent document 3) discloses a object detection sensor which uses an ultrasonic radar mounted on a ceiling or a side wall of a toilet so as to detect an abnormal condition within the toilet.

### SUMMARY OF THE INVENTION

There are security systems which employ a camera or an infrared sensor for detecting an intruder by monitoring predetermined indoor and outdoor areas. The system using a visible camera has low reliability in blind weather, or when dark at night. The system employing an infrared camera can be used at any time of the day or night, but is costly as compared with the system using the visible camera. Some infrared sensors which have a transmitting part and a receiving part detect interruption of received signal. These systems are likely to erroneously detect the object due to disturbance of incoming undesired objects, such as leaves of a tree or snow. Furthermore, an ultrasonic wave used in the patent document 3 is largely attenuated in air, and thus is not appropriate for outdoor use.

The conventional radar sensor, such as that disclosed in the patent document 2, can detect the intruder or the like only around an area where radio waves radiated intersects the ground when the sensor is mounted on a high position, such as in the vicinity of a roof of a building. As a result, the sensor cannot detect an object positioned in the vicinity of a position or spot directly under the radar sensor.

FIG. 13A is a sketch of an embodiment of setting a general object detection sensor 14 using a radar as viewed from a horizontal direction (laterally), and FIG. 13B is a plan view thereof as viewed from an upper side. Referring to FIGS. 13A and 13B, a monitoring surface, a monitoring area, a monitoring angle, and a vertex as described herein will be defined below. A zone for monitoring an object on a horizontal plane 34 (for example, the ground) is referred to as a monitoring surface 35. And, a conical space formed by the monitoring surface 35 and a vertex set in a position away from the monitoring surface 35 (for example, a point where a sensor 14 is mounted) is referred to as a monitoring area 16. An angle of the monitoring area 16 spreading from the vertex toward the monitoring surface 35 on a plane perpendicular to the horizontal surface 34 passing through the center of the monitoring surface 35 and the vertex is referred to as a monitoring angle α. Under these definitions, it is understood that the monitoring area 16 is formed providing the monitoring angle α from the vertex with respect to the monitoring surface 35. Furthermore, when the object detection sensor 14 is mounted on the vertex and the radio wave is radiated toward the monitoring surface 35, an antenna of the object detection sensor 14 is oriented downward, wherein an angle of the beam center of the antenna with respect to the horizontal direction is referred to as a depression angle.

As shown in FIGS. 13A and 13B, when using the general object detection sensor which has a narrow beamwidth and which radiates downward to the ground by orienting the antenna at the depression angle, an object existing closer to a building 15 away from the detectable monitoring area 16 cannot be detected. This problem is also raised in the device targeted for the indoor space as disclosed in the patent document 3. That is, it is difficult to detect an object existing in the vicinity of a position directly under the detection sensor mounted at the corner between the ceiling and the side wall. Additionally, in order to detect an intruder existing near an entrance of the building, the sensor has to be mounted at the same height as a person as disclosed in the patent document 2. In this case, the sensor may be disadvantageously found out by the intruder with ease.

Accordingly, the use of an object detection sensor 17, which includes an antenna having a wide beamwidth so as to compensate for an undetectable area, as shown in FIG. 14, may be proposed. In this case, however, in a radar system which does not measure an angle in a vertical direction, that is, an angle formed between the person and a vertical line extending from the sensor 17 to the ground, a distance from a point positioned directly under the radar sensor 17 to the target or the person cannot be determined uniquely. This fact will be explained hereinafter by taking as an example the detection of a standing person 10. When a distance between the radar sensor 17 and a head of the person is measured, an object of interest, namely, the person can be determined to exist on a circle with a radius corresponding to the distance from the center of the sensor 17 to the head, and on a broken line 18 within a radiation path of the radio wave, as is the case where a distance to a foot of the person is measured. Thus, by converting the detected position into a position within the monitoring surface, only the information that the object of interest may possibly be present inside the width designated by both arrows 19 is obtained, which disadvantageously results in large uncertainty in measuring position.

Furthermore, the radiatable power is limited, and hence when the antenna is used that has a wide beamwidth downward with respect to the monitoring surface as shown in FIG. 14, that is, in a vertical direction, a gain of the antenna is decreased. It is inevitable that this antenna has a short detectable distance as compared with the case of using an antenna which has a narrow beamwidth in the vertical direction.

Accordingly, it is an object of the invention to provide an object detection sensor which can accurately measure the position of an object within a predetermined monitoring area including the vicinity of a position directly under the sensor.

A typical embodiment of the invention achieves the above-mentioned object as follows. That is, an object detection sensor according to the embodiment comprises a radar device including at least one antenna, the radar device being adapted for emitting radio waves from the at least one antenna and for receiving a reflected wave from an object, and a signal processing circuit which performs a calculation for detection of the object using the received signal. A monitoring area is set to form a monitoring angle extending from a vertex toward a monitoring surface. When the object detection sensor is mounted on the vertex, a beam width of the at least one antenna in an elevation angle direction thereof is narrower than a width of the monitoring angle, and the detection of the object is performed changing depression angle of a beam center of the at least one antenna with respect to the monitoring surface.

Since the antenna having the beam width in the elevation angle direction narrower than the width of the monitoring angle is used for the monitoring area with the wide monitoring angle, the position of the object within the predetermined monitoring area including the vicinity of the position directly under the sensor can be measured with high accuracy. It should be noted that when the monitoring area is divided into plural monitoring sections, for example, plural antennas the number of which is identical to the number of the monitoring sections are used, the depression angles of the plural antennas toward the monitoring surface being different from each other. A depression angle for monitoring is changed by selecting from among the plural antennas.

According to the invention, an object detection sensor is expected to measure the position of the object accurately within the predetermined monitoring area including the vicinity of the position directly under the sensor.

These and other objects and many of the attendant advantages of the invention will be readily appreciated as the same becomes better understood by reference to the following detailed description when considered in connection with the accompanying drawings.

### BRIEF DESCRIPTION OF THE DRAWINGS

FIG. 1 is a configuration diagram for explaining an object detection sensor according to a first preferred embodiment of the invention;

FIG. 2A is a sketch for explaining the object detection sensor of the first embodiment as viewed in a horizontal direction;

FIG. 2B is a plan view for explaining the object detection sensor of the first embodiment;

FIG. 3 is a configuration diagram for explaining a circuit of the object detection sensor of the first embodiment;

FIG. 4 is a diagram for explaining two-frequency CW (Continuous Wave) modulation technique;

FIG. 5 is a sketch for explaining a method of measuring a distance within a monitoring surface according to the first embodiment as viewed from the horizontal direction;

FIG. 6A is a diagram showing the principle of monopulse angle measuring technique which is employed in a second embodiment of the invention;

FIG. 6B is another diagram showing the principle of monopulse angle measuring technique which is employed in the second embodiment;

FIG. 7 is a plan view for explaining an antenna used in the second embodiment;

FIG. 8 is a sketch for explaining a third preferred embodiment of the invention as viewed from the horizontal direction;

FIG. 9 is a sketch for explaining a fourth preferred embodiment of the invention as viewed from the horizontal direction;

FIG. 10 is a plan view for explaining a fifth preferred embodiment of the invention;

FIG. 11 is a sketch for explaining a sixth preferred embodiment of the invention as viewed from the horizontal direction;

FIG. 12 is a sketch for explaining a seventh preferred embodiment of the invention as viewed from the horizontal direction;

FIG. 13A is a sketch for explaining a conventional radar sensor with a narrow beamwidth;

FIG. 13B is a plan view for explaining the conventional radar sensor with the narrow beamwidth; and

FIG. 14 is a sketch for explaining a radar with a wide beamwidth as viewed from the horizontal direction.

### DETAILED DESCRIPTION OF THE PREFERRED EMBODIMENTS

Reference will now be made to an object detection sensor according to exemplary embodiments of the invention, which are illustrated in the accompanying drawings.

<First Embodiment>

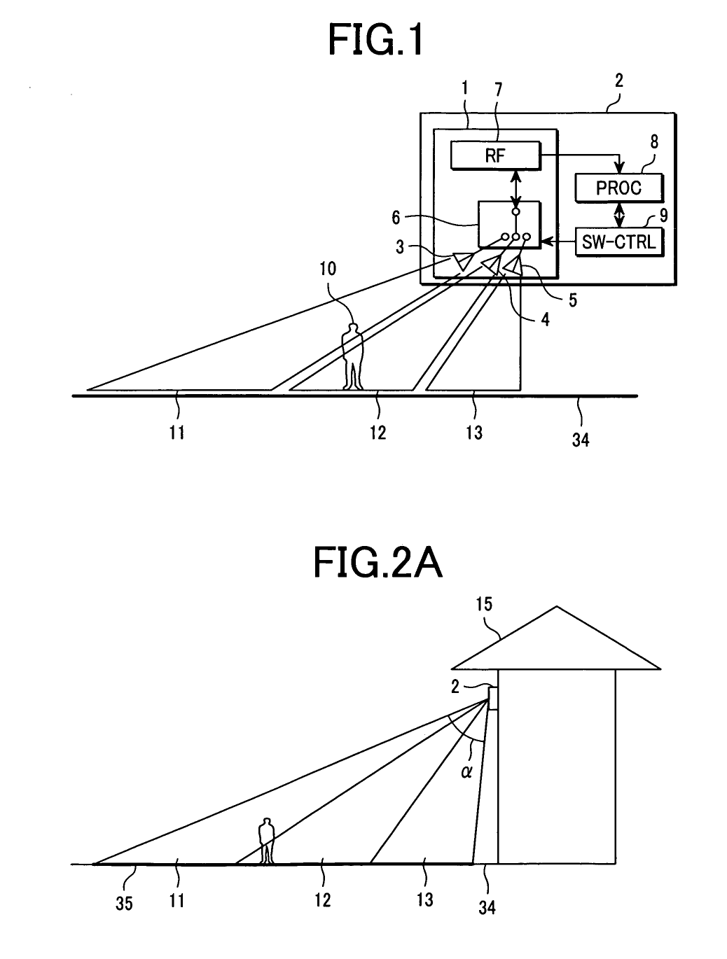

A first embodiment of the present invention will be described below using FIGS. 1, 2A, 2B, 3 and 4. Although in the embodiments, application of the object detection sensor will be explained by taking as an example a monitoring process of the outdoors of a house, the invention is not limited thereto. In the following description, a monitoring area is divided into three sections to detect intruders. When the monitoring area is divided into plural sections, each section is hereinafter referred to as a monitoring section.

FIG. 1 is a block diagram showing a configuration of an object detection sensor 2 of the embodiment. The object detection sensor 2 includes a radar device 1, a signal processing circuit (PROC) 8 for calculating target position using signals from the radar device 1, and an antenna switching control section (SW-CTRL) 9 for switching among the antennas based on a result of the processing performed by the signal processing circuit 8. Furthermore, the radar device 1 includes antennas 3, 4, and 5 mounted therein to have three different depression angles, an antenna selector switch 6 for switching among the antennas 3, 4, and 5 controlled by the antenna switching control section 9, and a radio frequency circuit (RF) 7 for transmitting and receiving signals to and from the antenna selector switch 6, while outputting the detection signal to the signal processing circuit 8. A monitoring area is divided into monitoring sections 11, 12, and 13, and a person 10, who is an object of interest for detection, exists over the monitoring sections 11 and 12.

With this arrangement, the antennas 3, 4, and 5 have the respective radiation directions at different angles from each other with respect to the horizontal direction, that is, at different depression angles. This causes the antennas 3, 4, and 5 to radiate respective radio waves toward the monitoring sections 11, 12, and 13, respectively. The beamwidth radiated downward from each of the antennas 3, 4, and 5 in the elevation angle direction is narrower than a width of an angle covering the monitoring area. The directivity of the antenna is defined by the beam width in the elevation angle direction as well as the beam width in the azimuth angle direction. Although the following describes three sets of pairs of transmitting and receiving antennas covering the respective monitoring sections, as one example, the invention is not limited thereto. For example, plural antennas may be only either of the transmitting antennas or the receiving antennas, and these antennas may be switched, while the other antenna may cover the entire three monitoring sections 11, 12, and 13, that is, the entire monitoring area. The radar device 1 may be, for example, a 24-GHz band radar, or a 76-GHz band radar.

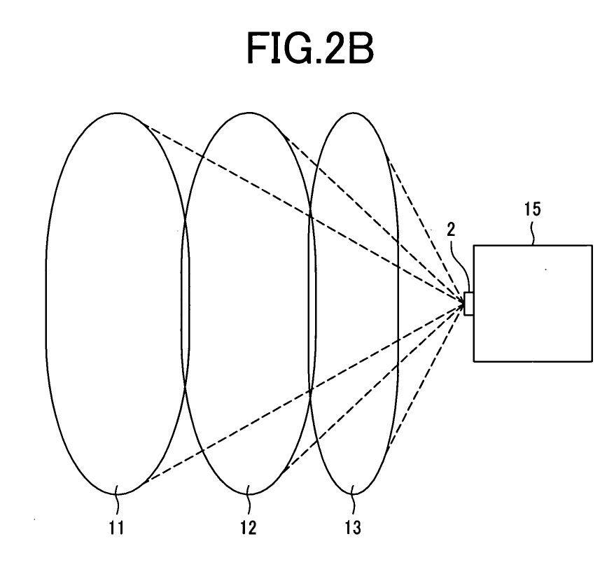

FIG. 2A is a sketch of the object detection sensor 2 mounted on an upper part of the wall of the building 15, and a radiation zone therefrom as viewed from the horizontal direction (laterally), and FIG. 2B is a plan view thereof as viewed from the upper side. The antennas have the respective monitoring sections 11, 12, and 13 as radiation zones which have different distances from a spot directly under the position in which the radar is mounted. As shown in FIG. 2A, the whole monitoring sections 11, 12, and 13 form the monitoring area with the monitoring angle α. As shown in FIG. 2B, the closer to the object detection sensor 2, the wider the beam width of the antenna in the azimuth angle direction is set.

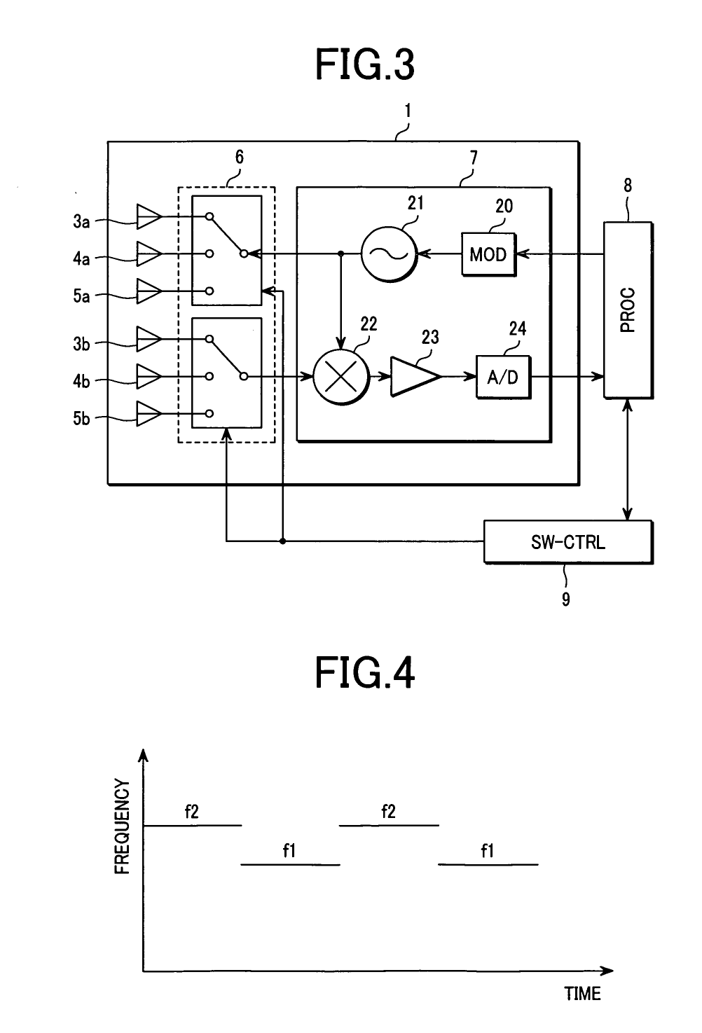

Next, the configuration of the radar device 1 will be described in detail with reference to FIG. 3. The radar device 1 has a transmitting system which includes a modulator 20, an oscillator 21, and transmitting antennas 3a, 4a, and 5a, as well as a receiving system which includes receiving antennas 3b, 4b, and 5b, a mixer 22, an analog amplifier circuit 23, and an A/D (Analog-to-Digital) converter 24. The radar device 1 further includes the antenna selector switch 6 for switching among plural antennas, the signal processing circuit 8, and the antenna switching control section 9.

The oscillator 21 oscillates at a frequency based on a modulating signal from the modulator 20. For example, the radio frequency wave is emitted toward the detection area 11 from the transmitting antenna 3a selected by the antenna switching control section 9.

Reference will now be made to the principle of the object detection by the radar when either one of two sets of pairs of antennas, for example, the antennas 3a and 3b are selected, that is, the principle of measurement of a distance from the object to the radar device 1 and of a velocity of the detected object, in adopting two-frequency CW modulation technique.

When applying two-frequency CW modulation technique, a modulating signal is input to the oscillator 21, and the radio waves are transmitted, while temporally switching among two frequencies f1 and f2 as shown in FIG. 4. In FIG. 4, a vertical axis indicates a frequency, and a horizontal axis indicates a time. The radio wave transmitted from the transmitting antenna 3a is reflected from the object 10 within the radiation area, and a radio wave returned is received by the receiving antenna 3b. This received signal is mixed with the transmission signal by the mixer circuit 22 to generate a intermediate-frequency signal, which is output to the analog amplifier circuit 23. A signal amplified by and output from the analog amplifier circuit 23 is converted into a digital signal by the A/D converter 24, and sent to the signal processing circuit 8.

The signal processing circuit 8 applies the fast Fourier transform to the digital signal from the A/D converter 24 to determine a frequency spectrum, thereby extracting a peak frequency of the reflected signal from the moving object. The peak frequency extracted and a phase are measured to calculate the velocity of the object and the distance from the radar device 1 to the object according to the following principle.

The peak frequency is a Doppler frequency when the object is moving or traveling, and hence the velocity (v) is determined by the following equation (1):
v=c×fd/(2f) (1)
where c is the speed of light, fd is the Doppler frequency, and f is an oscillation frequency.

For the Doppler frequency fd extracted, the phases corresponding to the frequency f1 and the frequency f2 are measured, and hence a distance (Range) is determined from a difference Φ between these phases based on the principle of two-frequency CW modulation technique by the following equation (2):
Range=c×Φ/(4π×Δf) (2)
where Δf=f2−f1.

By using the antenna 3, 4, and 5 in succession, the entire monitoring area is monitored at all times.

It is apparent that for measuring the distance and velocity, a FM-CM radar or a pulse radar may be used to have the same effect. The use of these systems makes it possible to detect a static object. Thus, even if an intruder is not moving, the intruder can be detected. When the azimuth angle position of an intruder is required to be determined, a method for mechanically rotating a radar, or a method for electronically rotating an azimuth angle direction of a beam radiated may be adopted as well as monopulse angle measuring technique as described in the next embodiment.

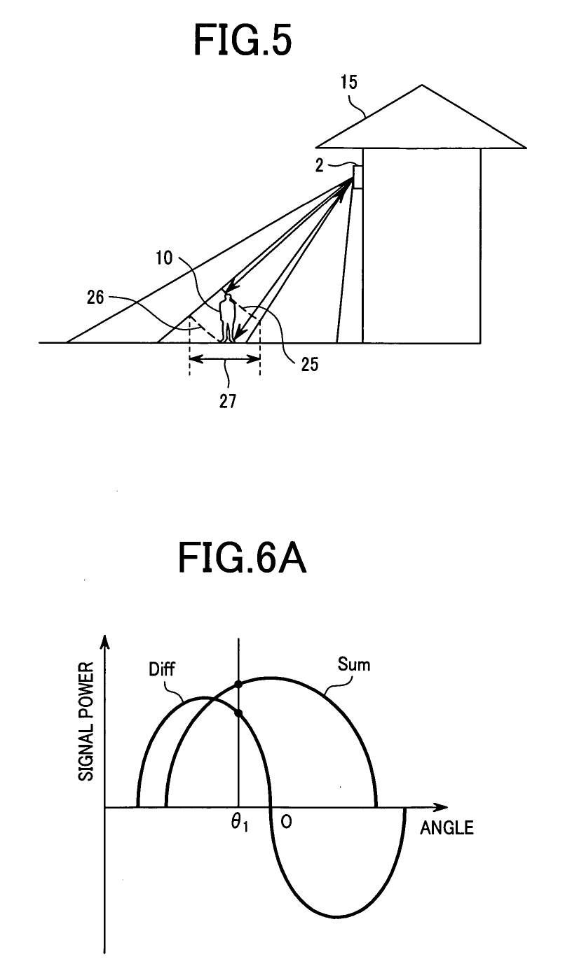

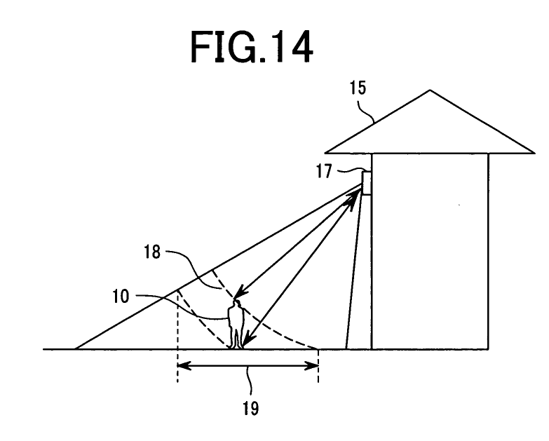

FIG. 5 illustrates a case where the object (person) 10 is detected within the radiation areas of the antennas 4a and 4b. The signal processing circuit 8 stores therein a radio wave radiation path from the antenna 4, and a distance is measured from the radio waves reflected from the head and foot of the person 10. This determines that the person 10 exists within a range defined by dashed lines 25 and 26. The signal processing circuit 8 performs a calculation for projecting the dashed lines 25 and 26 on the monitoring surface, so that a position of the person 10 on the monitoring surface is calculated as a range indicated by both arrows 27. The range indicated by both the arrows 27 is shorter than that by both arrows 19 shown in FIG. 14. This shows that the accuracy of the measured position of the target object is improved as compared to the case of FIG. 14.

In the above embodiment, three antennas 3, 4, and 5 are used whose beam widths in the elevation angle direction are narrower than the widths of the monitoring angles, instead it is possible to use only one antenna whose beam width in the elevation angle direction is narrower than the width of the monitoring angle and to rotate the antenna on a plane perpendicular to the monitoring surface to have the same effect.

<Second Embodiment>

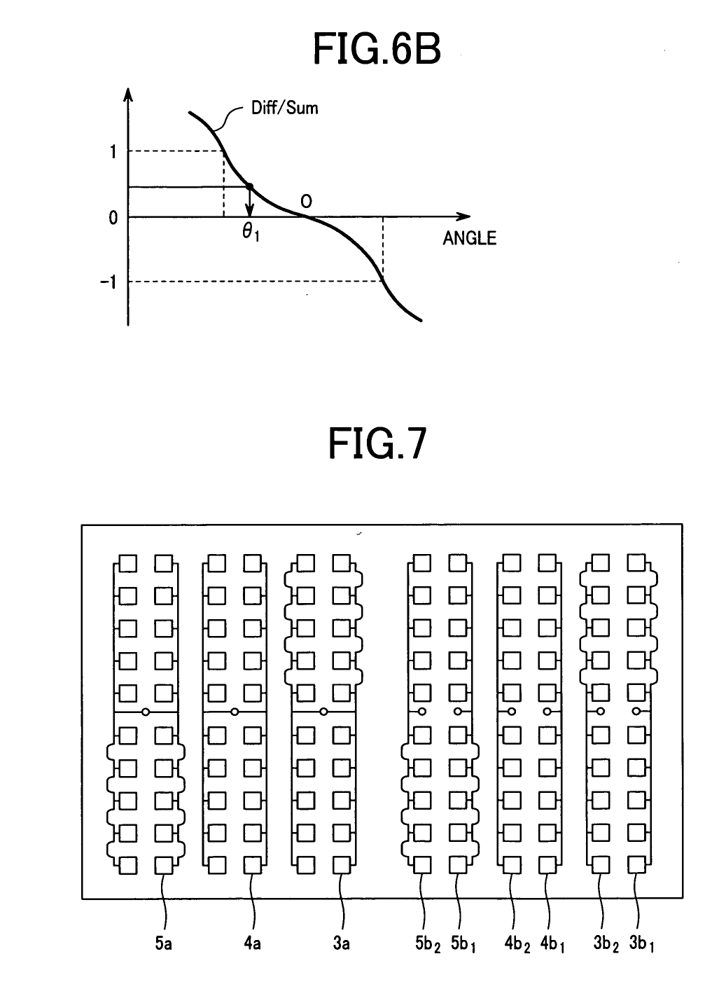

A second embodiment of the present invention will be described below using FIGS. 6A, 6B, and 7. In this embodiment, a monopulse technique is employed to measure an azimuth angle position of the target. The basic configuration of the object detection sensor of the second embodiment is shown in FIGS. 1 and 3. When applying monopulse technique, the receiving antenna is divided into two sections, and the azimuth angle is measured by using a sum signal and a difference signal received by the two divided antennas. The power dependency of the sum signal (Sum) and the difference signal (Diff) on the respective azimuth angles are illustrated in FIG. 6A. From this dependency, a ratio of the difference signal to the sum signal Diff/Sum is determined, which is illustrated in FIG. 6B. The azimuth angle Θt is determined according to the ratio value. The above-mentioned calculation is performed by the signal processing circuit 8.

An example of the configuration of the antennas applying the monopulse technique is illustrated in FIG. 7. Each antenna is composed of patch antennas, and three sets of pairs of transmitting and receiving antennas are arranged in one plane. Each of the transmitting antennas 3a, 4a, and 5a is provided with a corresponding feeding point. The receiving antenna 3b is divided into an antenna 3b1 and an antenna 3b2, the receiving antenna 4b into an antenna 4b1 and an antenna 4b2, and the receiving antenna 5b into an antenna 5b1 and an antenna 5b2. Each antenna divided is provided with a feeding point. The three sets of pairs of transmitting and receiving antennas have different depression angles. Thus, feeder lines of the upper halves of the transmitting antenna 3a, and the receiving antennas 3b1 and 3b2 are set long, and feeder lines of the lower halves of the transmitting antenna 5a and the receiving antennas 5b1 and 5b2 are set long. This arrangement can provide the downsized radar device 1 at a low cost. It will be obvious that the monopulse radar is also feasible using an antenna other than the patch antenna.

The distance to the detected object from a radar sensor can be estimated by knowing which antenna is used to detect the object. Furthermore if employing both of this monopulse technique and the two-frequency CW modulation technique in the first embodiment, it is possible to determine the distance and the azimuth angle at the same time.

<Third Embodiment>

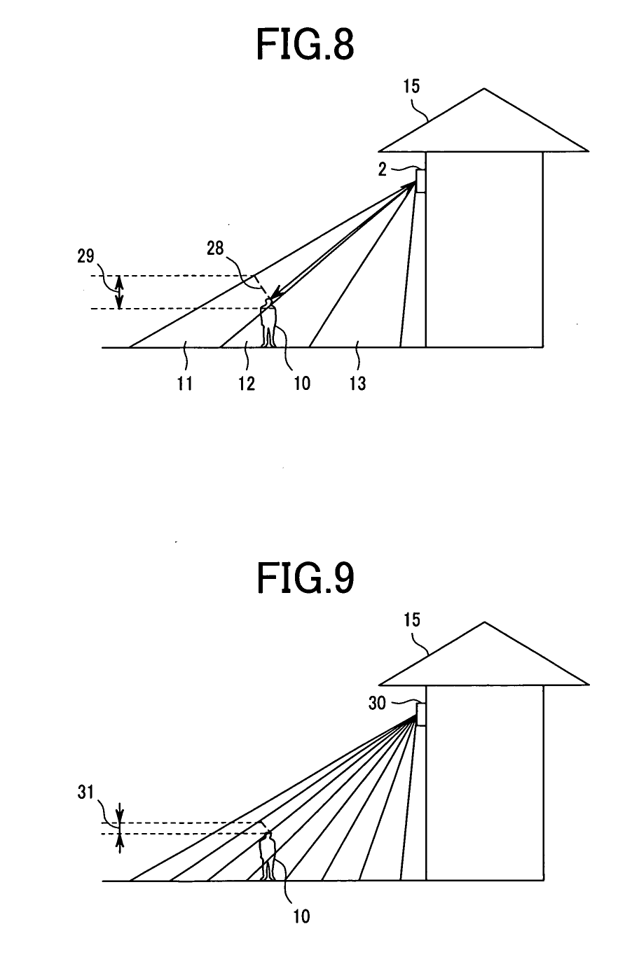

A third embodiment of the present invention will be described below using FIG. 8. FIG. 8 illustrates a case where the person 10 is detected by both antennas 3 and 4. The signal processing circuit 8 stores therein the radiation path which is radiated from the antenna 3, and a distance is measured from the radio waves reflected from the head of the person 10. And thus it is possible to determine that the head of the detected object or the person exists on a dashed line 28.

In the embodiment, the signal processing circuit 8 has an additional function of performing a calculation for projecting the dashed line into a surface perpendicular to the monitoring surface. This calculation determines that the height of the detected object is within a range indicated by both arrows 29. Thus, in this embodiment, the height of the detected object can be measured.

<Fourth Embodiment>

A fourth embodiment of the present invention will be described below using FIG. 9. In this embodiment, the number of divided sections of the monitoring area is increased, and the number of antennas of an object detection sensor is increased with increased number of the divided sections. FIG. 9 illustrates an object detection sensor 30 having, for example, seven sections into which the monitoring area is divided. In this case, a distance is measured from a signal obtained by an antenna selected from among antennas detecting the person 10, and corresponding to the furthest section from the building 15 as a detection zone. This calculation determines that the height of the detected object is within the range indicated by both arrows 31 in the same principle as described above. Thus, the larger the number of divisions and the narrower the width of each divided section, the better improved the measurement accuracy of the height of the object can be. Furthermore, also in this case, the measurement accuracy of the distance can be improved.

<Fifth Embodiment>

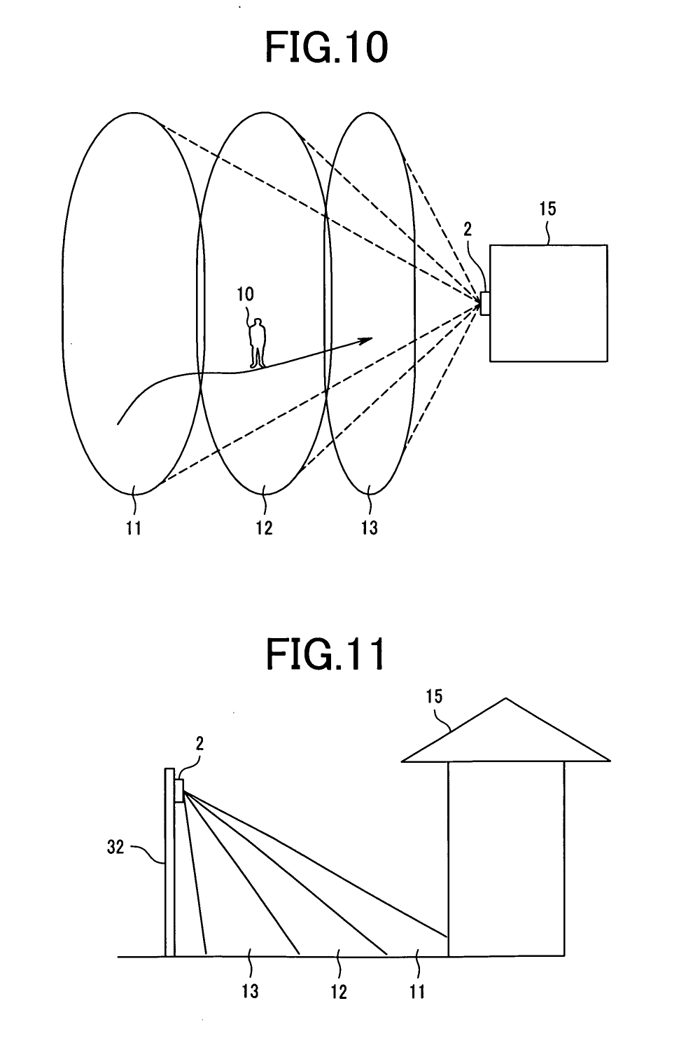

A fifth embodiment of the present invention will be described below using FIG. 10. FIG. 10 illustrates a case where the person intruding into the monitoring area is approaching the building. In the embodiment, when the intruding object into the monitoring area is detected, the antenna selector switch 6 (FIGS. 1 and 3) is controlled to switch among the antennas according to the intrusion path. This enables the sensor to follow the object detected.

First, for example, the antenna 3 corresponding to the monitoring section 11, detects the person. As the person 10 moves to the monitoring sections 12 and 13, the antenna selector switch 6 switches from the antenna 3 to the antenna 4, and then to the antenna 5. As mentioned above, the moving object is stably followed and monitored, and thus determined the intruding object approaching the building.

<Six Embodiment>

A sixth embodiment of the present invention will be described below using FIG. 11. As shown in FIG. 11, the object detection sensor 2 can be mounted on a location apart from the building 15. Mounting the sensor on a columnar member 32, such as an outside light, or a standing timber, can make it difficult for the intruder to find the setting of the object detection sensor 2.

Even when the object detection sensor 2 were mounted on the building 15 as is the case with the first embodiment, the object positioned in the vicinity of a position directly under the object detection sensor 2 could be detected, but the detectable zone in the vicinity of the position directly under the sensor might be narrow because of the radio waves radiated in a fan-like form from the antenna. In this sixth embodiment, it is possible to widen the detectable zone in the vicinity of the position which might be directly under the sensor if the sensor were mounted on the building 15.

<Seventh Embodiment>

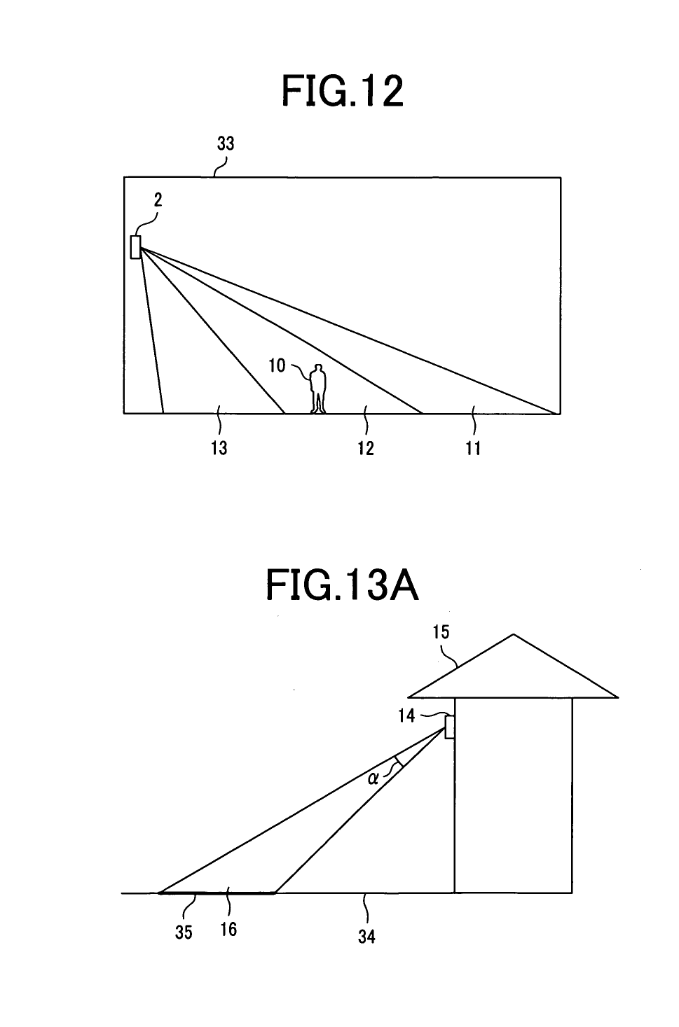

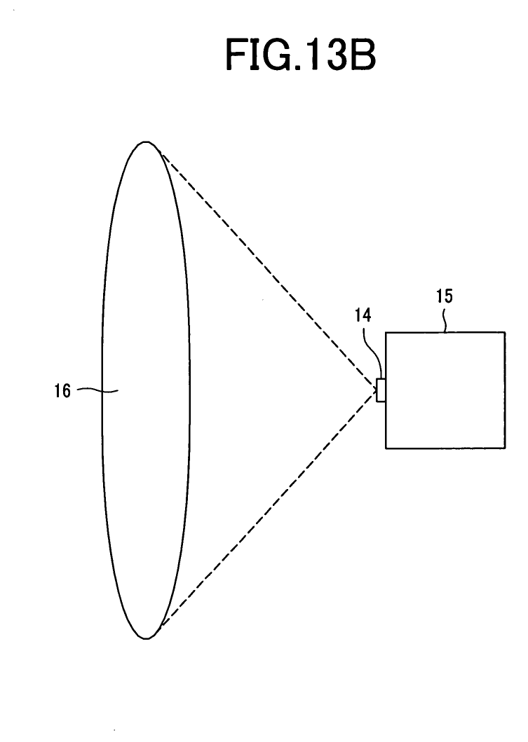

A seventh embodiment of the present invention will be described below using FIG. 12. FIG. 12 illustrates an example in which the object detection sensor 2 is mounted on the inside wall of a room 33. The applications of the object detection sensor 2 of the invention may include the monitoring of a flow of people as well as the monitoring of the intruder outdoors. For example, the detection sensor may be mounted on the wall inside a shopping center to follow the position of a purchaser or the like.

It is further understood by those skilled in the art that the foregoing description concerns preferred embodiments of the disclosed device and that various changes and modifications may be made in the invention without departing from the spirit and scope thereof.

What is claimed is:

1. An object detection sensor comprising:
a radar device including at least one antenna, the radar device being adapted for emitting radio waves from at least the one antenna and for receiving a reflected wave from an object; and
a signal processing circuit which performs a calculation for detection of the object using an output signal from the radar device,
wherein a monitoring area is set to form a monitoring angle extending from a vertex toward a monitoring surface,
wherein, when the object detection sensor is mounted on the vertex, a beam width of the at least one antenna in an elevation angle direction thereof is narrower than a width of the monitoring angle, and
wherein the detection of the object in the monitoring area is performed changing depression angle of a beam center of at least the one antenna with respect to the monitoring surface.

2. The object detection sensor according to claim 1,
wherein the monitoring area is divided into a plurality of monitoring sections,
wherein the number of the antennas is identical to the number of the monitoring sections, and the depression angles of the respective beam centers of the plurality of antennas toward the monitoring surface are different from each other, and
wherein a monitoring section is selected by selecting an antenna from among the plurality of antennas.

3. The object detection sensor according to claim 2,
wherein the monitoring surface includes a vicinity of a part where a vertical line extending from the vertex with respect to a horizontal plane including the monitoring surface intersects with the horizontal surface.

4. The object detection sensor according to claim 2,
wherein the beam widths of the plurality of antennas in the respective elevation angle directions thereof are different from each other.

5. The object detection sensor according to claim 1,
wherein, in the calculation for the detection of the object performed by the signal processing circuit, a distance from one of at least the one antenna detecting the object to the object is verified against a radio-wave radiation path of the antenna, and a position of the object on the monitoring surface is determined based on the verification.

6. The object detection sensor according to claim 1,
wherein, in the calculation for the detection of the object performed by the signal processing circuit, a distance from one of the at least one antenna detecting the object to the object is compared with a radio-wave radiation path of the antenna, and a size of the object in a vertical direction with respect to the monitoring surface is calculated based on the comparison.

7. The object detection sensor according to claim 4,
wherein the selection from the plurality of antennas is carried out in order of the value of the depression angle of the beam center of the antenna with respect to the monitoring surface.

8. The object detection sensor according to claim 4,
wherein, when the monitoring section where the object is exits is shifted to another as the object moves, the selection from the plurality of antennas is carried out by selecting the antenna whose detection zone corresponds to the monitoring section where the object exists, thereby following the movement of the object.

9. The object detection sensor according to claim 1,
wherein the radar device employs two-frequency CW modulation technique, and the distance to the object is measured by the signal processing circuit.

10. The object detection sensor according to claim 1,
wherein the radar device applies monopulse angle measuring technique, and an azimuth angle position of the object is measured by the signal processing circuit.

11. The object detection sensor according to claim 1,
wherein the object detection sensor is mounted on a wall surface of a house.

12. The object detection sensor according to claim 1,
wherein the object detection sensor is mounted on a wall surface indoors.

13. The object detection sensor according to claim 1,
wherein the object detection sensor is mounted on a columnar member standing outdoors.

14. An object detection sensor comprising:
a radar device including a transmitting antenna and at least one receiving antenna, the radar device being adapted for emitting radio waves from the transmitting antenna and for receiving a reflected wave from an object by at least the one receiving antenna; and
a signal processing circuit which performs a calculation for detection of the object using an output signal from the radar device,
wherein a monitoring area is set to form a monitoring angle extending from a vertex toward a monitoring surface,
wherein, when the object detection sensor is mounted on the vertex, a beam width of the transmitting antenna in an elevation angle direction thereof is substantially identical to a width of the monitoring angle, and a beam width of at least the one receiving antenna in an elevation angle direction thereof is narrower than a width of the monitoring angle, and
wherein the detection of the object in the monitoring area is performed changing depression angle of a beam center of at least the one receiving antenna toward the monitoring surface.

15. The object detection sensor according to claim 14,
wherein the monitoring area is divided into a plurality of monitoring sections,
wherein the number of the receiving antennas is identical to the number of the monitoring sections, and the depression angles of the respective beam centers of the plurality of receiving antennas with respect to the monitoring surface are different from each other, and
wherein a monitoring section is selected by selecting an antenna from among the plurality of receiving antennas.

16. The object detection sensor according to claim 15,
wherein the monitoring plane includes a vicinity of a part where a vertical line extending from the vertex with respect to a horizontal surface including the monitoring surface intersects with the horizontal surface.

17. An object detection sensor comprising:
a radar device including a receiving antenna and at least one transmitting antenna, the radar device being adapted for emitting radio waves from at least the one transmitting antenna and for receiving a reflected wave from an object by the receiving antenna; and
a signal processing circuit which performs a calculation for detection of the object using an output signal from the radar device,
wherein a monitoring area is set to form a monitoring angle extending from a vertex toward a monitoring surface,
wherein, when the object detection sensor is mounted on the vertex, a beam width of the receiving antenna in an elevation angle direction thereof is substantially identical to a width of the monitoring angle, and a beam width of at least the one transmitting antenna in an elevation angle direction thereof is narrower than a width of the monitoring angle, and
wherein the detection of the object in the monitoring area is performed changing depression angle of a beam center of at least the one transmitting antenna toward the monitoring surface.

18. The object detection sensor according to claim 17,
wherein the monitoring area is divided into a plurality of monitoring sections,
wherein the number of the transmitting antennas is identical to the number of the monitoring sections, and the depression angles of the respective beam centers of the plurality of transmitting antennas with respect to the monitoring surface are different from each other, and
wherein a monitoring section is selected by selecting an antenna from among the plurality of transmitting antennas.

19. The object detection sensor according to claim 18,
wherein the monitoring surface includes a vicinity of a part where a vertical line extending from the vertex with respect to a horizontal plane including the monitoring surface intersects with the horizontal surface.
